(19) United States
(12) Patent Application Publication
(10) Pub. No.: US 2022/0068003 A1
(43) Pub. Date: Mar. 3, 2022

(54) THIRD-PARTY INJECTED, OPENLY IMPLEMENTED, COLLABORATIVE VIRTUAL WRAPPING

(71) Applicant: Thomas Knapp-Ramos, Honolulu, HI (US)

(72) Inventor: Thomas Knapp-Ramos, Honolulu, HI (US)

(21) Appl. No.: 17/407,176

(22) Filed: Aug. 19, 2021

Related U.S. Application Data
(60) Provisional application No. 63/072,165, filed on Aug. 29, 2020.

(51) Int. Cl. G06T 13/80; G06T 11/00

(52) U.S. Cl. CPC G06T 13/80; G06F 3/0482; G06T 11/00

(57) ABSTRACT

A method of virtual wrapping wherein the overall human experience is significantly enhanced with key human-centric innovations providing significant improvements in convenience, uniqueness, and meaningfulness.

### CROSS-REFERENCE TO RELATED APPLICATIONS

This patent application claims the benefit of and priority to U.S. Provisional Patent Application No. 63/072,165 filed Aug. 29, 2020. The present application is related to application serial number US 20140164159A1 filed Jun. 12, 2014 which is not admitted to be prior art with respect to the present invention by its mention in the cross-reference section.

### FIELD

The claimed technology relates generally to virtual wrapping, and more specifically, to a content-agnostic, third-party injected, openly interactive, openly customizable, brandable, collaborative virtual wrapping wherein the claimed virtual wrapping technology is not limited to the virtual wrapping of gifts. Gifting is a common application of virtual wrapping nonetheless.

### BACKGROUND

With the advent of digital gift giving, contrary to in-person gifting, recipients of digital gifts no longer enjoy the fun, interactive “gift experience” traditionally achieved via the use of various customary physical elements including but not limited to the opening of a card, untying of a bow, and unwrapping of gift wrap.

Innovative virtual experiences have been added to the delivery experience of digital gifts in an attempt to provide a “gift experience” with the delivery of digital gifts. Such virtual experiences use various forms of digital media, which may include the use of graphics, animation, sound, and/or interaction to give recipients of digital gifts with a “gift experience.” Such technology is known as “virtual gift wrap” or, more generally, “virtual wrapping,” where virtual wrapping is not limited to the wrapping of gifts.

However, there has not yet been an invention of virtual wrapping that has seen substantial commercial success to-date. And, the reason behind such lack of commercial success is due to lack of the proper innovations and inventions.

Previous inventions of virtual wrapping have generally consisted of either two-dimensional or prerendered graphics and/or limited interactions that trigger various predefined or basic animations. Such previous virtual wrapping inventions, for instance, have included a basic image of a gift box with a timer showing when the gift will be revealed, a collection of images that must be swiped away to reveal a gift underneath, or interactions with various elements that predictably trigger prerendered animations, such as short videos, to start playing.

Despite creative uses of interactive digital media technologies seen in previous inventions of virtual wrapping, the application of creative digital media alone is not enough. Much like a theatrical play, anyone can wear a costume on a stage and call it a play, but wearing a costume on a stage does not mean that the play will become successful. Costumes and a stage alone are not enough for a successful play. Virtual wrapping inventions are no different. Previously invented virtual wrappings have ultimately lacked core human elements in the “overall human experience.” Overall human experience is the complete experience for all parties involved in a given setting. In the context of virtual wrapping, this includes the sender(s), the recipient(s), the contexts in which senders and recipients are in, and everything else in the process of interacting with virtual wrapping.

A virtual wrapping invention consisting of a timer that counts down until a gift can be revealed satisfies the elements of suspense for recipients as well as ease-of-use for senders, but is lacking in other areas of overall human experience. What if a sender is sending a last-minute gift? In the case of a last-minute gift, the time would be near-zero, thus rendering the timer useless. If the only component of the unwrapping experience was a timer, then recipients of gifts would not feel the element of suspense at all.

A virtual wrapping invention consisting of a collection of images, uploaded personally by senders, that recipients must swipe away to reveal a gift that is underneath satisfies elements of suspense as well as personalness for the recipient, but is lacking in other areas of overall human experience. Consider how many images must be swiped away for a gift recipient to have a reasonable unwrapping experience. Three? Four? Now, consider how many personal images people generally readily have on-hand which are suitable for a virtual wrapping intended to be delivered to some given recipient at any given time. Likely not many. Likely none. The sender experience is part of the overall human experience, but it is evident that a virtual wrapping invention consisting of a series of images that must be swiped away is not sender-friendly due to a lack of convenience.

A virtual wrapping invention consisting of prerendered animation(s) for recipients to watch satisfies the the element of ease-of-use for senders, as senders simply have to select an animation from a list of selections, but is lacking in other areas of overall human experience. Recipients of virtual wrappings consisting of prerendered animations can clearly see that the same animation can easily be sent to many other individuals, and hence voids all elements of personalness.

As can be seen, the overall human experience of virtual wrappings is complex and has many elements. Such elements include ease-of-use, personalness, time-insensitivity, convenience, and availability. Failure to address any given element within the overall human experience of virtual wrappings leads to commercial failure. An invention of virtual wrapping that satisfies the elements within the overall human experience, without ignoring any given element, requires significant innovation beyond what has currently been seen as of today.

### SUMMARY

The invention claimed in this document is content-agnostic, third-party injected, openly interactive, openly customizable, brandable, collaborative virtual wrapping.

A virtual wrapping that is content-agnostic can wrap arbitrary content. A content-agnostic virtual wrapping is not limited to the wrapping of virtual content, but can also wrap physical objects in the real world via the innovative use of augmented reality and/or virtual reality. The ability to virtually wrap physical content enables a unique opportunity to save paper.

A virtual wrapping that is third-party injected is directly accessible to individuals within third parties. A third-party injected virtual wrapping allows individuals to conveniently interact with the virtual wrapping within third parties without having to leave the third party. A third party is any physical or virtual location outside of the context of the invention claimed in this document such as a physical store or online store.

A virtual wrapping that is openly interactive is one in which user interactions dynamically manipulate the environment in real-time as opposed to triggering preset or prerendered animations to play. An openly interactive virtual wrapping allows users to feel like they are actually wrapping and/or unwrapping their virtual wrapping, thus providing a significantly better overall human experience.

A virtual wrapping that is openly customizable is one in which users can upload arbitrary content and organize that content onto elements of the virtual wrapping however they choose. An openly customizable virtual wrapping enables creative openness and freedom when customizing virtual wrappings, thus providing a significantly better overall human experience.

A virtual wrapping that is brandable can have third-party elements added to the virtual wrapping that are unique to the third party. A brandable virtual wrapping allows gifts to be associated with brands and is a significant improvement in branding for businesses and other third parties.

A virtual wrapping that is collaborative can be interacted with by multiple users at the same time in real-time. A collaborative virtual wrapping allows multiple users to have a shared experience, thus providing a significantly better overall human experience considering the fact that humans are social creatures by nature.

Open interactivity solves the problem of last-minute gifts. Unlike previous virtual wrapping invetions which utilized a timer counting down until a gift is revealed to provide the element of suspense, an openly interactive virtual wrapping provides suspense via interaction with a dynamic environment. An openly interactive virtual wrapping is time-insensitive. A timer-based virtual wrapping is time-sensitive, and therefore fails to address a vital element of overall human experience.

Open customization solves the problem of personalness while also providing convenience and ease-of-use. Unlike previous inventions of virtual wrapping that have utilized a sequence of images uploaded by virtual wrapping senders for the implementation of virtual wrapping, an openly customizable virtual wrapping enables senders of virtual wrappings to add their personal input without the necessity of having content, such as quality images, readily available on-hand.

Additionally, open interactivity significantly aids in solving the problem of personalness. Unlike previous inventions of virtual wrapping that have utilized prerendered animations, open interactivity naturally makes each wrapping and unwrapping experience unique considering the number of possible states are virtually infinite for a real-time dynamically manipulated environment of elements.

Third-party injectability satisfies the element of convenience, which is a core element in the overall human experience of virtual wrapping for senders of virtually wrapped content. Brandability provides a unique opportunity for brands to increase their overall brand awareness and ultimately increase overall brand value. Collaboration provides an even further opportunity to increase personalness through enabling shared experiences with other individuals.

### BRIEF DESCRIPTION OF THE DRAWINGS

FIG. 1 is a high-level activity diagram displaying various actors along with systematic activities and their relations.

FIG. 2 details the process of third-party integration.

FIG. 3 details the wrapping process.

FIG. 4 details the unwrapping process.

FIG. 5 details the content interface.

FIG. 6 displays an example of a third-party front-end integrated with the invention claimed in this document.

FIG. 7 displays an example of a content selection user interface for virtually wrapping third-party content.

FIG. 8 displays an example of open customizability along with several pregenerated customizability options for convenience.

FIG. 9 displays an example of a branded user interface for virtual wrapping.

FIG. 10 displays an example of virtual wrapping taking place in a physical third-party front-end environment.

FIG. 11 displays collaborative wrapping.

FIG. 12 displays an example of unwrapping a virtual wrapping through a hand-held computer.

FIG. 13 displays an example of unwrapping a virtual wrapping through a wearable computer.

FIG. 14 displays collaborative unwrapping.

FIG. 15 displays an example of virtual wrapping applied to physical objects.

FIG. 16 displays arbitrary forms of virtually wrapped content as well as arbitrary forms of virtual wrappings.

### DETAILED DESCRIPTION

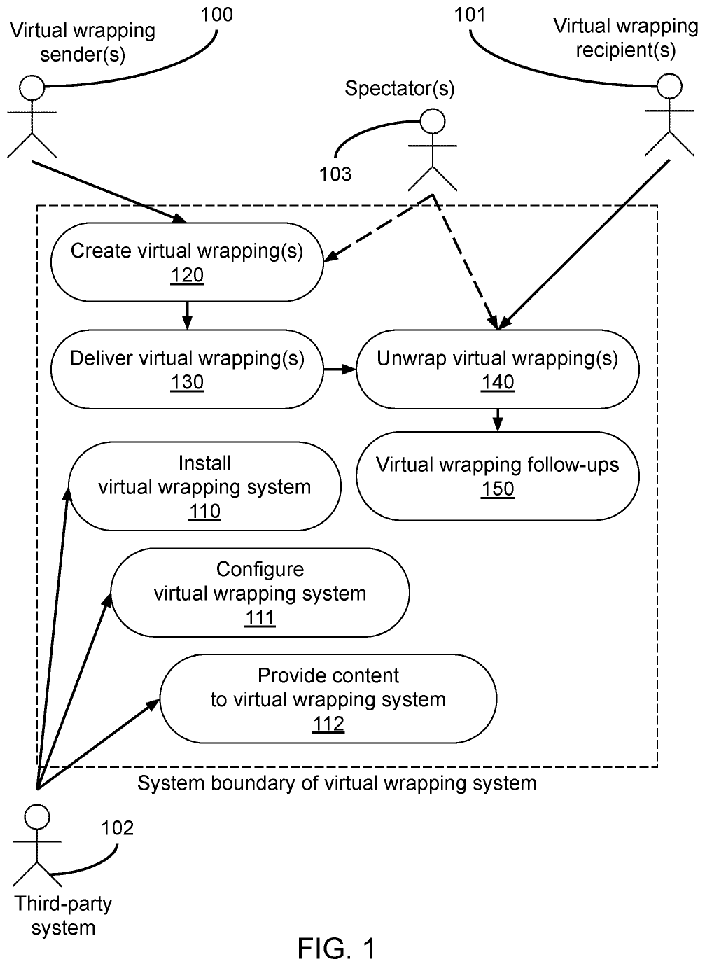

The activity diagram of the invention claimed in this document depicted in FIG. 1 displays several actors involved in the process of content-agnostic, third-party injected, openly interactive, openly customizable, brandable, collaborative virtual wrapping in relation to the activities performed by the invention claimed in this document. Elements 100-103 represent actors. Elements within the range of 110-150 represent system activities.

Element 100 represents individual(s) who are sending virtual wrappings. Element 100 can represent a single sender or a multitude of senders.

Element 101 represents individual(s) who are recipients of virtual wrappings that are sent by virtual wrapping senders 100. Element 101 can represent a single recipient or a multitude of recipients.

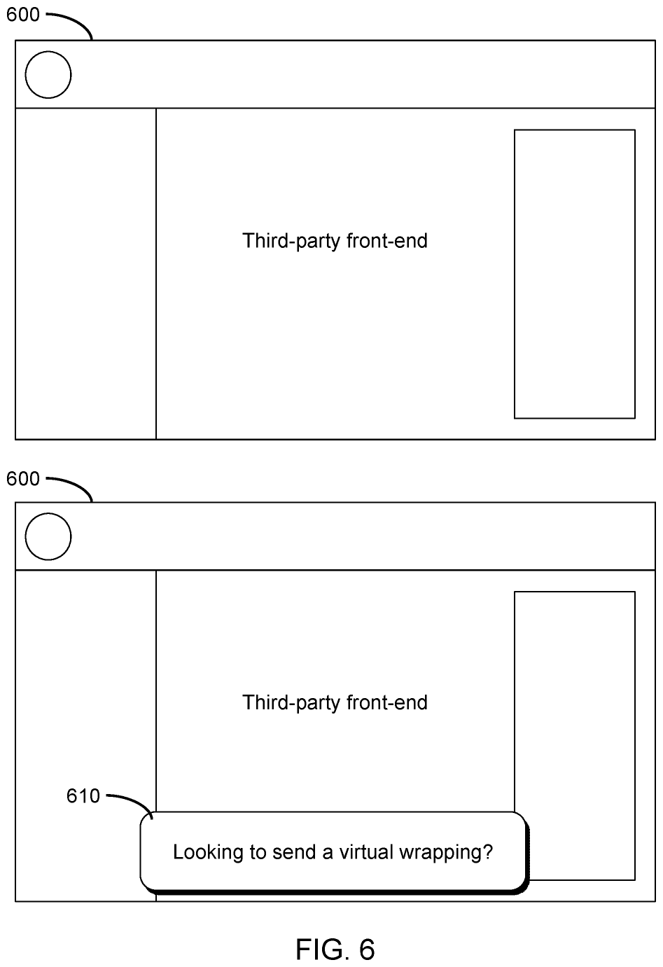

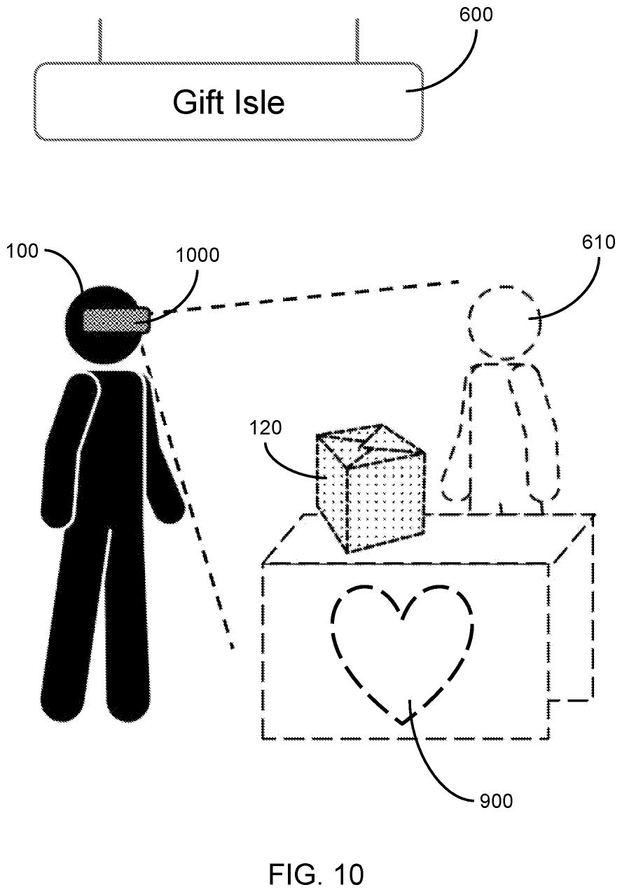

Element 102 represents a third-party system. A third-party system 102 is any entity that can be integrated with the invention claimed in this document. Third-party systems 102 have a front-end 600. A third-party front-end 600 consists of the elements which users can interact with when using a third-party system 102. A third-party front-end 600 can have a physical existence, such as a traditional walk-in store as depicted in FIG. 10, or a virtual existence, such as a website as depicted in FIG. 6.

Element 103 represents spectator(s). Element 103 can represent a single spectator or a multitude of spectators. Spectators 103 are individuals who are viewing or optionally interacting with virtual wrappings. Spectators 103 can spectate throughout any step of the virtual wrapping process including but not limited to wrapping 120 and unwrapping 140.

Systems and individuals involved with invention claimed in this document can assume the role of any actor or multiple actors. For instance: A virtual wrapping sender 100 can spectate a virtual wrapping while recipient(s) 101 are unwrapping 140 virtual wrappings thus assuming the role of a spectator 103; A third-party system 102 can send virtual wrappings thus assuming the role of a sender 100; A third-party system 102 can spectate the unwrapping of virtual wrappings thus assuming the role of a spectator 103; To describe a few examples.

Element 110 represents the integration of a systematic implementation of the invention claimed in this document into a third-party system 102.

Element 111 represents the configuration of a systematic implementation of the invention claimed in this document when integrated with a third-party system 102. When configuring 111 a systematic implementation of the invention claimed in this document, various settings are applied to the integration of the invention claimed in this document by the said third-party system 102. Such configurations, for instance, can include selecting products that can be virtually wrapped, selecting colors for theming the integration, or adding unique elements to the virtual wrappings for senders 100, recipients 101, and spectators 103 to interact with.

Element 112 represents the activity of providing information regarding content that can be virtually wrapped by the invention claimed in this document. Third-party systems 102 providing information regarding content that can be virtually wrapped 112 is a key activity required for being content-agnostic.

Element 120 represents the creation, or wrapping process, of the virtual wrappings performed by senders 100 as well as spectators 103.

Element 130 represents the delivery process of virtual wrappings. The delivery 130 of virtual wrappings can be achieved via a plurality of means including but not limited to email, SMS, and social media.

Element 140 represents the unwrapping of the virtual wrappings performed by recipients 101 as well as spectators 103.

Element 150 represents follow-up activities performed after a virtual wrapping is delivered 130 and unwrapped 140 that contribute to the improved overall human experience for users of the invention claimed in this document.

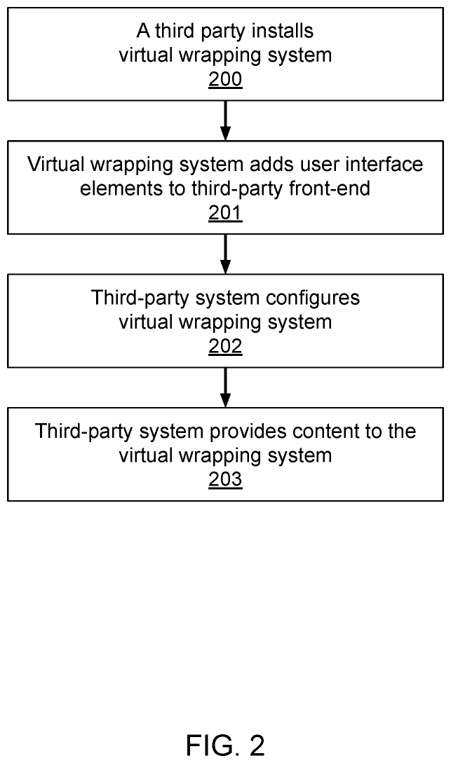

The process diagrams in FIGS. 2-4 display the steps involved in the invention claimed in this document. At a high level, there are three such steps: integration 110, wrapping 120, and unwrapping 140.

The process diagram in FIG. 2 displays the steps involved when a systematic implementation of the invention claimed in this document is injected into a third-party system 102.

First 200, said third-party system 102 integrates 110 with a systematic implementation of the invention claimed in this document. The integration generally requires several additions and changes to said third-party system 102. Then 201, the invention claimed in this document adds user interface elements to said third-party front-end 600. Such user interface elements can be, for example, widgets on a website or virtual reality content placed virtually in a physical store. Then 202, said third-party system 102 configures 111 their integration of the invention claimed in this document. Such configurations can include the application of unique colors and textures allowing the individual integration of the invention claimed in this document to conform to the third-party system's 102 unique brand. Lastly 203, said third-party system 102 provides virtually wrappable content 112 to systematic implementations of the invention claimed in this document.

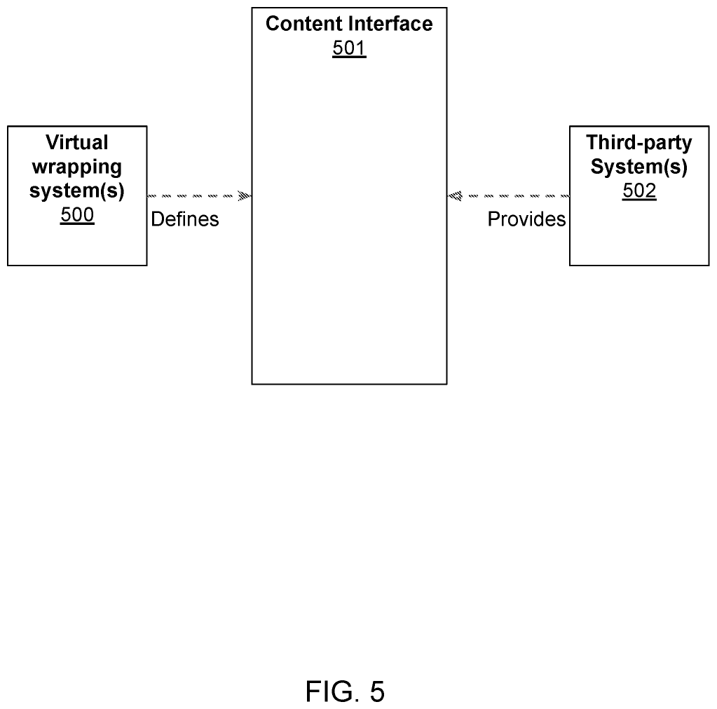

The system block diagram in FIG. 5 displays the systematic elements that enable third-party systems 102 to provide virtually wrappable content 112 to a systematic implementation of the invention claimed in this document. The systematic implementation of the invention claimed in this document contains a content subsystem 500 that defines a content interface 501. The content interface 501 is a protocol that allows third-party systems 102 to provide virtually wrappable content to the systematic implementation of the invention claimed in this document. Element 502 represents the content subsystem of third-party systems 102 that communicates with the content interface 501.

The content provided by third-party systems 102 through the content interface 501 can be provided to multiple systematic implementations of the invention claimed in this document such that the content can be displayed across multiple channels. Such channels can include websites for the affiliate sales of products on other third-party systems 102 and third-party front-ends 600 thereof.

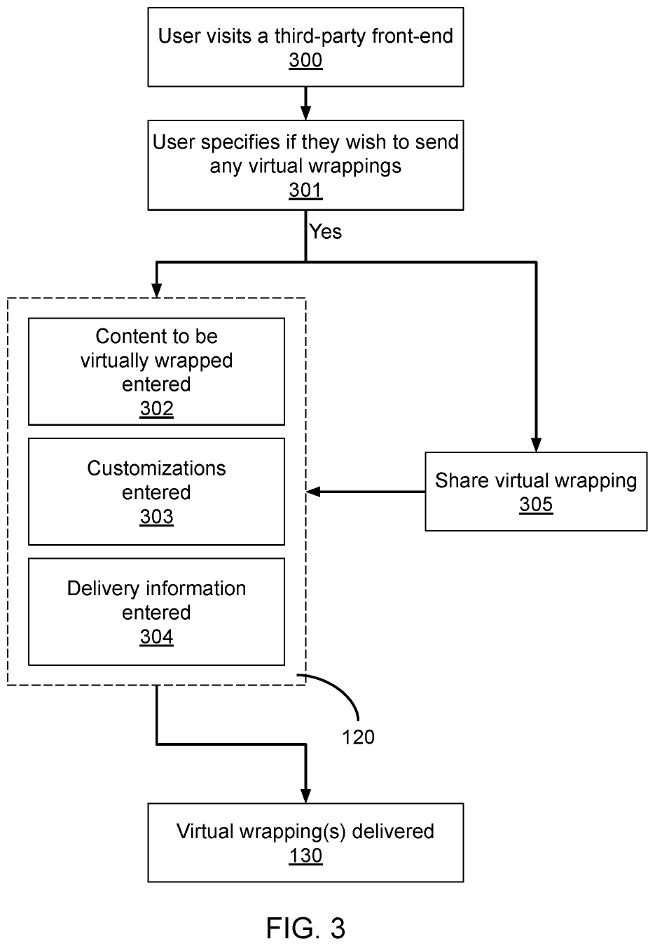

The process diagram in FIG. 3 displays the steps involved in the creation, or wrapping process, of content-agnostic, third-party injected, openly interactive, openly customizable, brandable, collaborative virtual wrapping.

First 300, a user enters a third-party front-end 600. The user can then interact with the systematic implementation of the invention claimed in this document and decide if they would like to virtually wrap 120 any content. Users who decide to send virtually wrapped content 100 can proceed to wrap content by creating virtual wrappings 120. Then 302, users 100 can select content 710 to be virtually wrapped where the content is provided via the content interface 501. Then 303, users 100 can enter and apply their personal customizations to their virtual wrappings. Then 304, users 100 can enter delivery information regarding how they would like their virtual wrappings to be delivered to their intended recipient or recipients 101. Steps 302-304 can happen in any arbitrary order. Additionally 305, users 100 can choose to share their virtual wrappings with additional senders 100 and spectators 103. Lastly 130, virtual wrappings are delivered. The delivery 130 typically happens after a checkout process. Senders 100 can send multiple virtual wrappings to multiple recipients 101.

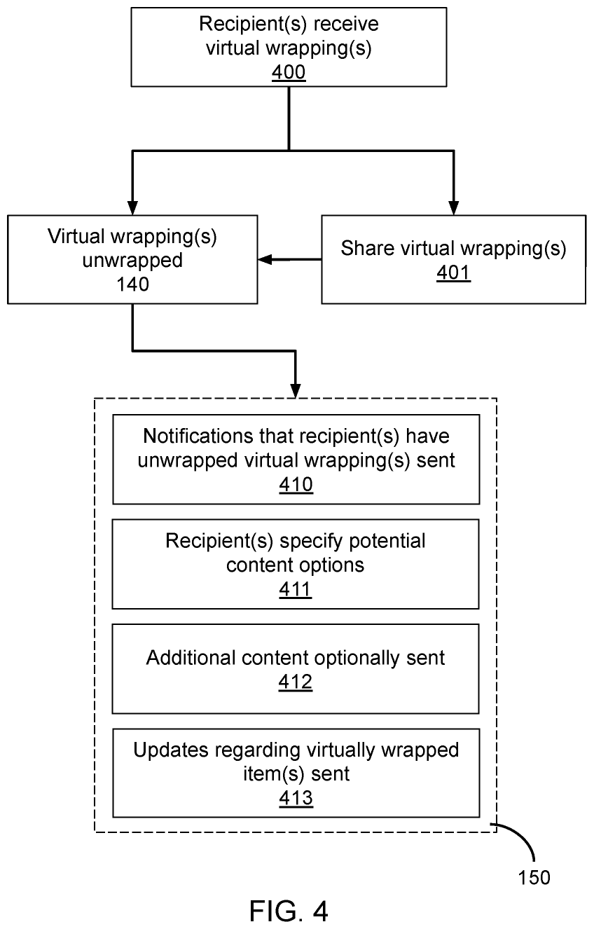

The process diagram in FIG. 4 displays the steps involved in the unwrapping of content-agnostic, third-party injected, openly interactive, openly customizable, brandable, collaborative virtual wrapping.

First 400, a recipient, or a group of multiple recipients, 101 receive their virtual wrapping or virtual wrappings via whichever means of delivery 130 they discover their delivered virtual wrapping or virtual wrappings. Then 140, the recipients 101 unwrap the virtual wrapping. Additionally 401, recipients 101 can share their virtual wrapping with additional recipients 101 or spectators 103. Once the unwrapping 140 of virtual wrappings is completed, the next phase is a multitude of unwrapping follow-ups 150.

Element 150 in FIG. 4 displays several examples of possible follow-ups 150. Examples of follow-ups 150 disclosed in this document are, but are not limited to, the examples in the following sentences. Senders of the virtual wrappings 100 can be notified 410 that the virtual wrapping has been unwrapped 140. If the virtually wrapped content requires additional selections to be made prior to the fulfillment of said content, then recipients 101 can select options 411 regarding the virtually wrapped content. Such content options 411 can be to choose a specific product variant, such as a shoe size, for instance. Additionally, follow-up content can be sent 412 to senders 100, recipients 101, and spectators 103. Examples of follow-up content 412 can be, but are not limited to, thank you notes, useful information, promotional content, or additional virtual wrappings. Lastly, 413 updates regarding the status of the wrapped content can be sent to involved parties. An example of an update 413 is, for instance, the shipping status of a physical item being delivered after a virtual wrapping has been unwrapped 140.

FIG. 6 displays an example realization of a third-party front-end 600 wherein the third-party front-end 600 is composed of virtual user interface elements. Element 610 displays an example front-end of a systematic implementation of the invention claimed in this document injected into a third-party front-end 600.

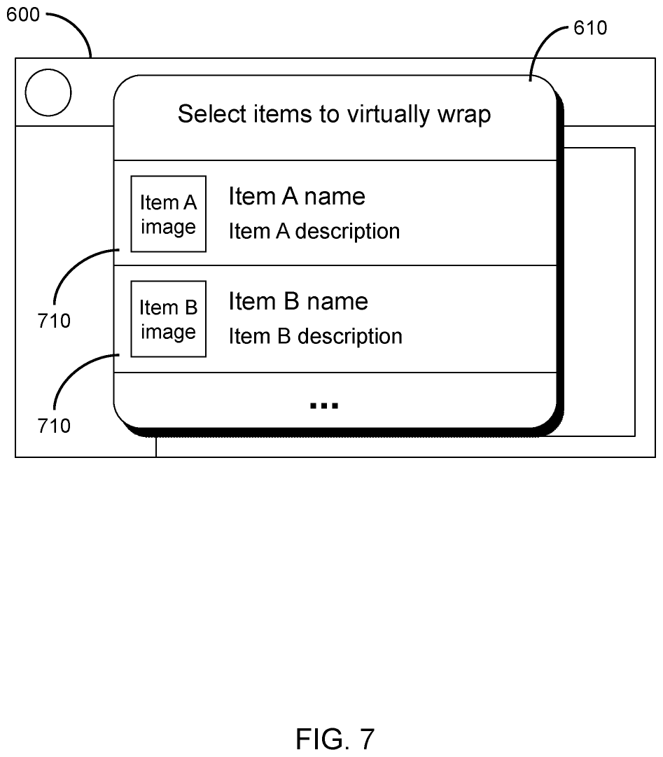

FIG. 7 displays an example realization of user interface elements in a front-end of a systematic implementation of the invention claimed in this document 610 displaying wrappable content 710 that is made available through the content interface 501.

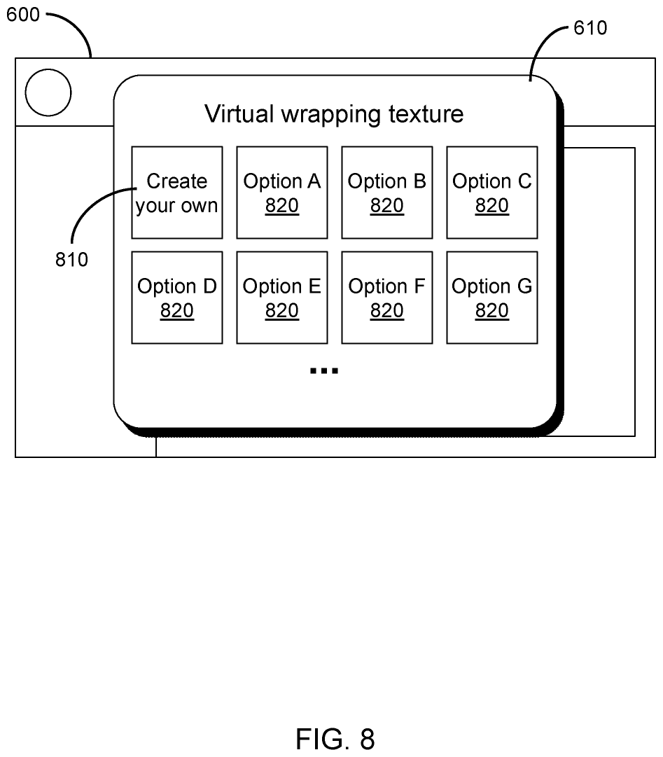

FIG. 8 displays an example realization of open customizability 810. In the context of FIG. 8, the open customizability 810 displayed is the ability for senders 100 to create any texture that they can imagine for their virtual wrapping, hence the term “open customization.” Such open customizability 810 includes, but is not limited to, uploading images, selecting colors, and adding shapes. Open customizability 810 can be applied to all elements in the virtual wrapping. Additionally, open customizability 810 can be applied to the addition of additional elements within virtual wrappings, such as adding virtual confetti, for instance. Additional elements that are added to virtual wrappings are openly customizable 810; for instance, the properties of added confetti can be openly customized with the same degree of flexibility as all other elements. Open customizability is a significant improvement in overall human experience of virtual wrappings as it allows senders of virtual wrappings 100 to create very unique, individually personalized virtual wrappings. For convenience, a systematic implementation of the invention claimed in this document can still provide pregenerated options for customization 820.

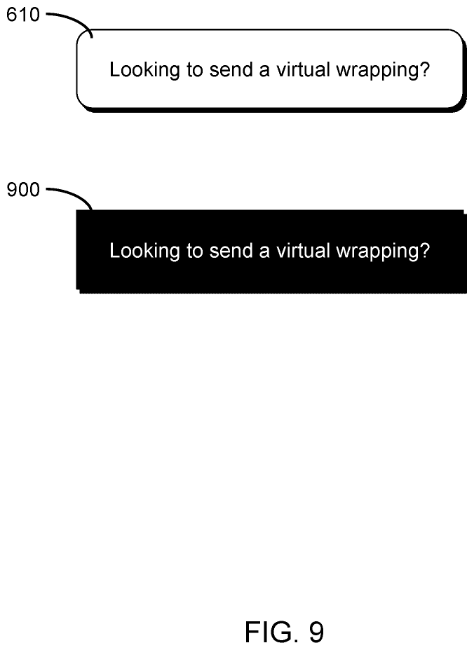

The illustration in FIG. 9 displays the front-end 610 of a systematic implementation of the invention claimed in this document being branded 900 to fit the unique branding of the third-party system 102. In the context of FIG. 9, the unique branding 900 is a dark theme with sharp corners as opposed to a light theme with rounded corners.

The illustration in FIG. 10 displays an example utilization of the invention claimed in this document in a physically realized third-party front-end 600. In the context of FIG. 10, the sign 600 represents an isle in a physically realized third-party front-end 600 such as a traditional walk-in store. Element 1000 represents a computing device that can display or render visual elements. In the context of the invention claimed in this document, a computing device 1000 includes, but is not limited to, handheld computers, wearable computers, desktop computers, servers, and point-of-sale terminals. Additionally, while a sender of a virtual wrapping 100 is wrapping 120 a virtual wrapping, senders 100 can physically maneuver dynamic elements within the virtual wrapping such that the recipient sees a uniquely wrapped virtual wrapping when unwrapping 140 said virtual wrapping. Such maneuvers can include but are not limited to senders 100 modifying the state of virtual paper in order to physically wrap content in a unique way.

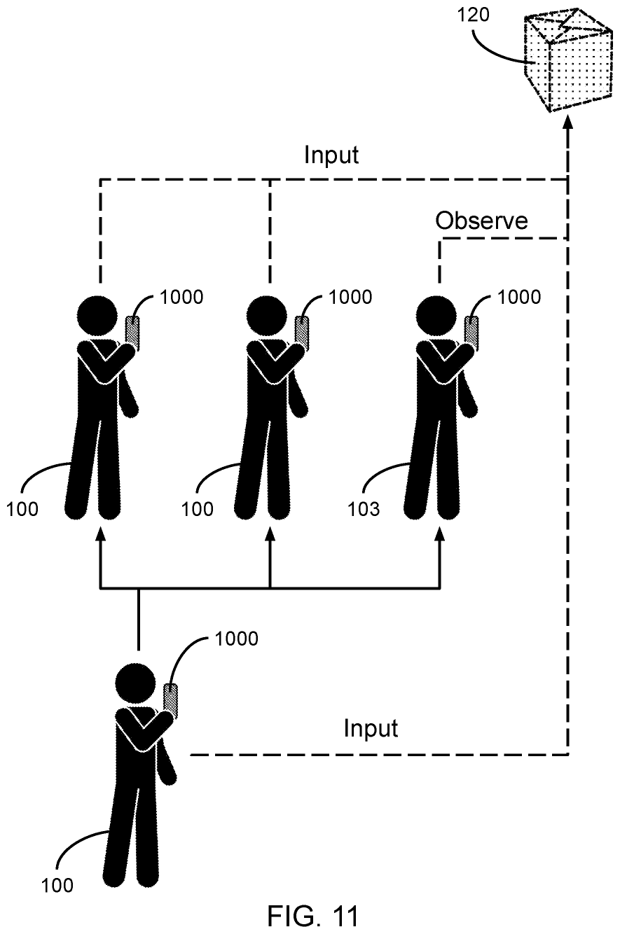

The flow diagram in FIG. 11 displays senders 100 and spectators 103 collaboratively customizing 120, wrapping 120, and viewing a virtual wrapping in real-time. The sender 100 has shared the virtual wrapping with other senders 100 and spectators 103. Furthermore, the degree of viewing permission of the wrapping process can be configured to enable potentially large amounts of spectators 103.

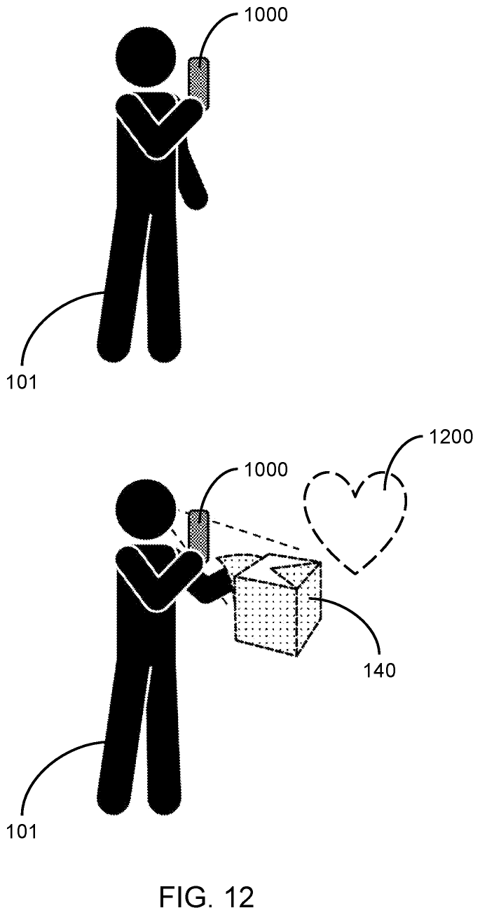

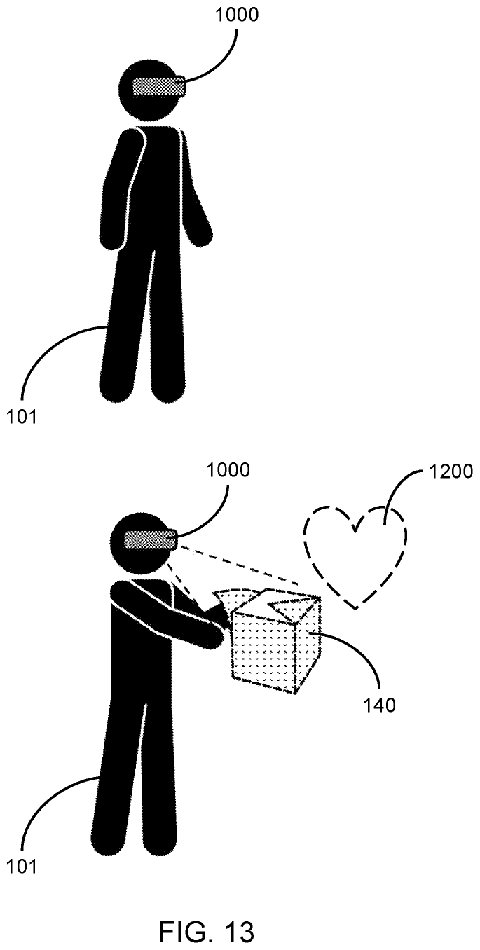

FIG. 12 and FIG. 13 illustrate various example realizations of recipients 101, computers 1000, and unwrapping virtual wrappings 140, as well as branding 1200 applied to the unwrapping of virtual wrappings. FIG. 12 illustrates an example using a hand-held computer 1000. FIG. 13 illustrates an example using a wearable computer 1000. When virtual wrappings are unwrapped 140, multimedia is used to enhance the overall human experience. Such multimedia can include, but is not limited to, audible sounds as the elements of virtual wrappings are interacted with.

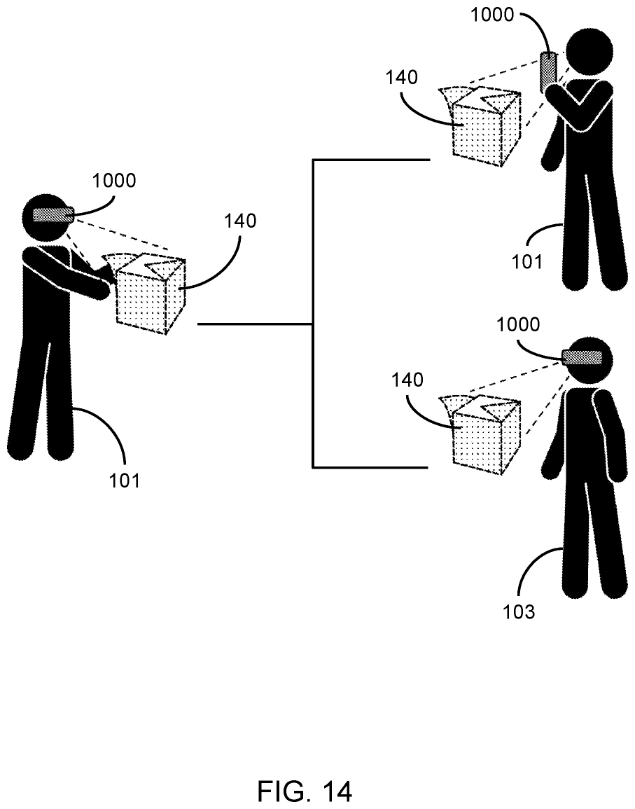

FIG. 14 illustrates the collaborative unwrapping of the invention claimed in this document. The degree of viewing permission of the unwrapping process can be configured to enable potentially large amounts of spectators 103.

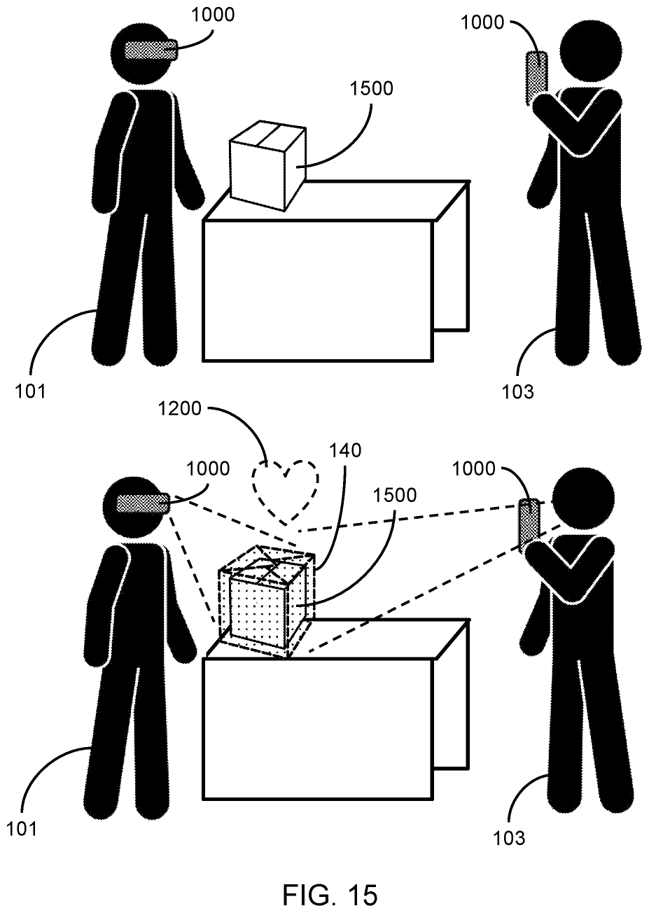

FIG. 15 illustrates the unwrapping of the invention claimed in this document applied to physical objects 1500 with the use of augmented reality through a wearable computer 1000. Said computer 1000 can identify unique markings, tags, or labels on physical objects 1500 in order to project virtual wrappings 140 onto said physical objects 1500. Furthermore, said computer 1000 can identify physical objects 1500 directly based on visual features of the objects themselves with the use of artificial intelligence in order to project virtual wrappings 140 onto said physical objects 1500.

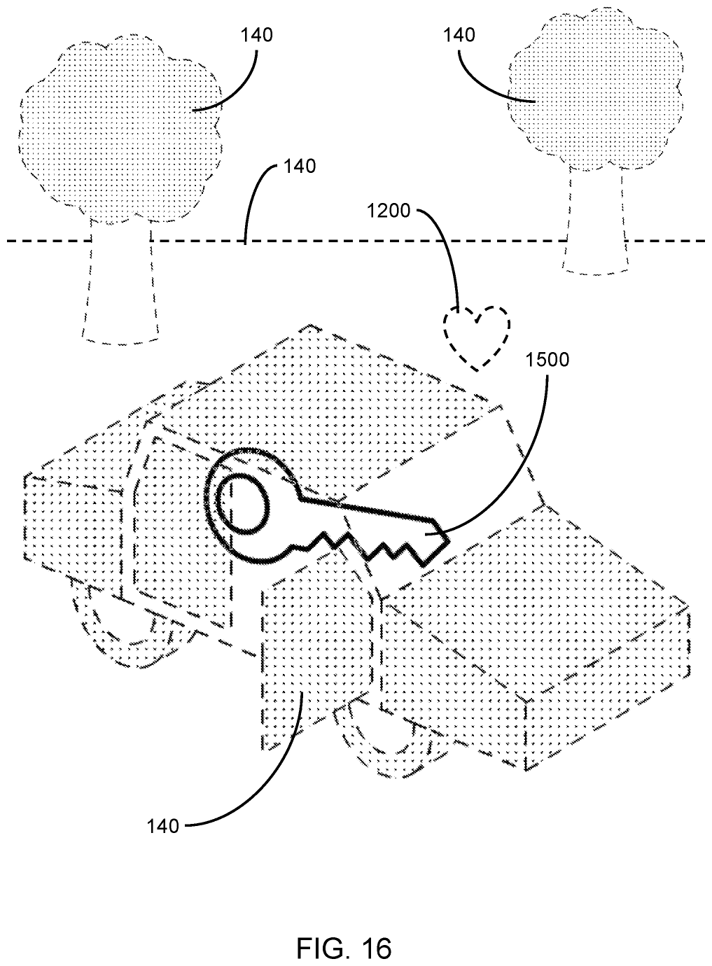

The interactive virtual wrapping of the invention claimed in this document can be configured in any arbitrary shape and can wrap arbitrarily shaped objects, virtual and physical. The interactive virtual wrapping of the invention claimed in this document is dynamically manipulated in real-time, and this notion is not limited to virtual paper nor box-shaped objects. For instance, FIG. 16 displays a virtual wrapping that is in the form of a car that is virtually wrapping a car key 1500 where the state of the doors can be dynamically manipulated and the car can be “unwrapped” 140 by opening the doors. Furthermore, all elements of the interactive virtual wrappings of the invention claimed in this document are part of the virtual wrapping itself, including, for instance, the surrounding scene 140. The surrounding scene 140 depicted in FIG. 16 contains elements such as interactive virtual trees 140 that recipients 101 and spectators 103 can interact with as part of the unwrapping of virtual wrappings 140. Sounds can be located throughout the space of the virtual unwrapping scene 140 that recipients 101 and spectators 103 can hear via audio devices.

What is claimed is:

1. A content-agnostic, third-party injected, openly interactive, openly customizable, brandable, collaborative virtual wrapping system, by a computer, comprising;
by a computer, a content-agnostic, third-party injected, openly interactive, openly customizable, brandable, collaborative wrapping subsystem;
by a computer, a content-agnostic, openly interactive, brandable, collaborative unwrapping subsystem.

2. A virtual wrapping system of claim 1 wherein said virtual wrapping system comprises the ability to wrap physical content through the use of augmented and virtual realities coupled with visual tagging or artificial intelligence systems for object identification.

3. A virtual wrapping system of claim 1 wherein said virtual wrapping system comprises user-manipulable dynamic properties computed in real-time enabling significant room for the scope of possibilities thus making each experience unique compared to preset animations or sequences of preset animations triggered by user interaction.

4. A virtual wrapping system of claim 1 wherein said virtual wrapping system elements can be customized to provide a unique brand experience when wrapping and/or unwrapping said virtual wrappings.

5. A virtual wrapping system of claim 1 wherein said wrapping subsystem is injected into a third-party system for users of the third party to conveniently interact with said wrapping subsystem.

6. A virtual wrapping system of claim 1 wherein users of said wrapping subsystem can interactively experience the said unwrapping subsystem while interacting with the said wrapping subsystem, such that users can visualize their virtual wrapping customizations as customizations are being made.

7. A virtual wrapping system of claim 1 wherein said wrapping subsystem allows users to provide and upload content without creative limitation as opposed to being limited to premade options to choose from.

8. A virtual wrapping system of claim 1 wherein said wrapping subsystem itself can be customized to fit a unique third-party brand.

9. A virtual wrapping system of claim 1 wherein said wrapping subsystem can be interacted with by multiple users simultaneously and/or at separate points in time allowing multiple users to provide their personal input as described in claim 7.

10. A virtual wrapping system of claim 1 wherein said unwrapping subsystem presents users with said virtual wrapping with customizations applied as described in claim 7.

11. A virtual wrapping system of claim 1 wherein said unwrapping subsystem can be projected onto physical objects via the use of augmented and virtual realities and is not limited to exclusively unwrapping virtual content nor virtual representations of physical content.

12. A virtual wrapping system of claim 1 wherein said unwrapping subsystem is openly interactive as described in claim 3 as opposed to pre-rendered content or animations triggered by user interaction.

13. A virtual wrapping system of claim 1 wherein said unwrapping subsystem can be customized to provide a unique brand experience when unwrapping said virtual wrapping.

14. A virtual wrapping system of claim 1 wherein said unwrapping subsystem can be interacted with by multiple users simultaneously and/or at separate points in time allowing multiple users to experience the unwrapping of said virtual wrapping.
